(19) United States
(12) Patent Application Publication
(10) Pub. No.: US 2016/0133380 A1
(43) Pub. Date: May 12, 2016

(54) Compact Twin-Shaft Bobbin Structure

(71) Applicant: YU JING ENERGY TECHNOLOGY CO., LTD., New Taipei City (TW)

(72) Inventor: Sen-Tai Yang, New Taipei City (TW)

(21) Appl. No.: 14/754,877

(22) Filed: Jun. 30, 2015

(30) Foreign Application Priority Data
Nov. 7, 2014 (TW) 103219792

(51) Int. Cl. H01F 27/32

(52) U.S. Cl. CPC H01F 27/325; H01F 27/323

(57) ABSTRACT

An improved compact twin-shaft bobbin structure includes penetrating first and second center through-holes on first and second bobbins, respectively. First and second winding slot groups having a plurality of adjacent respective first and second winding slots are provided on the outer peripheral sides of the first and second center through-holes, respectively. First and second receiving recesses laterally extend from ends of the first and second center through-hole, respectively. First and second pin groups and an opening are provided on ends of the first and second receiving recesses, respectively. Two clamping slots are provided on the top and bottom of the second winding slot group, respectively. A shield in the shape of an “n” is provided on one side of the second bobbin. The shield includes bent flanges along two edges thereof. The two flanges are inserted into the two clamping slots, respectively to fasten the shield to the second bobbin. When the first and second bobbins are juxtaposed with their openings adjacent to each other, the first and second receiving recesses are in communication with each other, while the first and two center through-holes extend in parallel to each other.

### BACKGROUND OF THE INVENTION

1. Field of the Invention

The invention relates to an improved compact twin-shaft bobbin structure, and more particularly, to a bobbin structure providing an obstructing shield between different bobbins to improve the insulation between different windings.

2. Description of the Prior Art

A traditional twin-shaft iron core transformer structure, such as the one disclosed, titled “Compact Transformer Structure with Twin-Shaft Iron Core”, essentially includes: a base, a first bobbin, at least a first winding group, a second bobbin and at least a second winding group. The base defines a plane and an axial direction substantially perpendicular to the plane. The first bobbin receives a first iron core in a first receiving space, and it has a first wing at a distance from the base. The first winding group is wound onto the outer peripheral surface of the first bobbin. The second bobbin receives a second iron core in a second receiving space, and it has a second wing at the distance from the base. An extending direction of the second iron core along the axial direction and an extending direction of the first iron core along the axial direction are spaced by an interval. The second winding group is wound onto the outer peripheral surface of the second bobbin. By having a twin-shaft structure, the height of the transformer in the axial direction can be significantly reduced.

In practice, as the first and second winding groups are directly wound in the winding slots of the first and second bobbins, and there is no obstruction between the two bobbins, the insulation between the first and second winding groups relies solely on the insulating layers of the winding coils themselves. As such, in some situations where more strict insulation are required, multiple insulating layers for the coils have to be adopted in order to satisfy the insulating requirements. However, multiple layers of insulation inevitably hinders the heat dissipation of the coils, which may cause the temperature of the coils to rise and in turn affects the stability of the transformer.

Moreover, the first and second windings are joined together as a whole. This makes it difficult to wind. The present invention separates the two windings, so they are wound independently, which makes the winding simpler and easier to control. However, if two separate coils are not secured in place, the stability of the inductance may be affected after assembly. In view of this, the present invention uses dovetail joints to secure the bobbins (with windings thereon) together in order to obtain a better control of the electrical characteristics such as inductance and leakage inductance.

In view of the shortcomings in the conventional transformer structure with a twin-shaft iron core, the present invention is proposed to provide improvements that address these shortcomings.

### SUMMARY OF THE INVENTION

One main objective of the present invention is to provide an improved compact twin-shaft bobbin structure that allows at least one shield to be provided between two bobbins depending on different insulating needs. By allowing different numbers of shields to be installed between the windings, different insulations can be achieved to satisfy the insulation requirements of various different safety standards.

Another objective of the present invention is to provide an improved compact twin-shaft bobbin structure that, in addition to having a center through-hole for an iron core to pass through, includes a receiving recess in communication with the center through-hole laterally for enclosing other local parts of the iron core to meet the various safety inspection specification.

Yet another objective of the present invention is to provide an improved compact twin-shaft bobbin structure that includes a plurality of adjacent winding slots on the bobbins, so that different number of turns of the coils can be provided in each slot to adjust and thus achieve a balance in leakage inductance.

In order to achieve the above objectives and efficacies, the technical means employed by the present invention may include: a first bobbin including a penetrating first center through-hole and a first winding slot group having a plurality of adjacent first winding slots on the outer peripheral side of the first center through-hole, a laterally extending first receiving recess formed at one end of the first center through-hole, and a first pin group including a plurality of pins and an opening provided on two ends of the first receiving recess, respectively; a second bobbin including a penetrating second center through-hole, a second winding slot group having a plurality of adjacent second winding slots and two clamping slots on the outer peripheral side of the second center through-hole, a laterally extending second receiving recess formed at one end of the second center through-hole, and a second pin group including a plurality of pins and an opening provided on two ends of the second receiving recess, respectively, wherein a shield in the shape of an “n” is provided on one side of the second bobbin, the shield further includes bent flanges along two edges thereof, the two flanges are inserted into the two clamping slots, respectively, to fasten the shield to the second bobbin; when the first and second bobbins are juxtaposed with their openings adjacent to each other, the first and second receiving recesses are in communication with each other, while the first and two center through-holes extend in parallel to each other with the first and second pin groups arranged at the sides of the first and second bobbins, respectively.

In the above structure, a first coupling portion and a first coupled portion are provided on two sides of the opening of the first bobbin, respectively, and a second coupling portion and a second coupled portion are provided on two sides of the opening of the second bobbin, respectively, the first coupling portion is correspondingly connected with the second coupled portion and the second coupling portion is correspondingly connected with the first coupled portion.

In the above structure, the first and the second coupling portions are dovetail tenons, and the first and the second coupled portions are dovetail grooves.

In the above structure, the two clamping slots are provided on the top and bottom of the second winding slot group, respectively.

The objectives, efficacies and features of the present invention can be more fully understood by referring to the drawing as follows:

### BRIEF DESCRIPTION OF THE DRAWINGS

FIG. 1 is an exploded view of the structure in accordance with the present invention.

FIG. 2 is a perspective view of the assembled structure in accordance with the present invention.

FIG. 3 is a cross-sectional view of the assembled structure in accordance with the present invention.

### DETAILED DESCRIPTION OF THE PREFERRED EMBODIMENTS

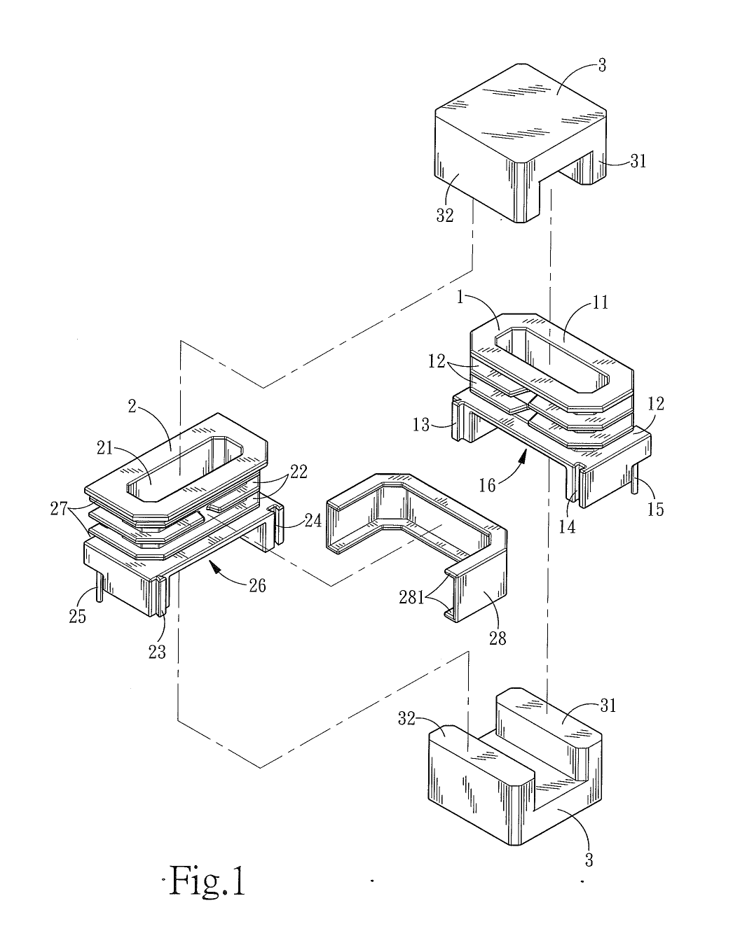

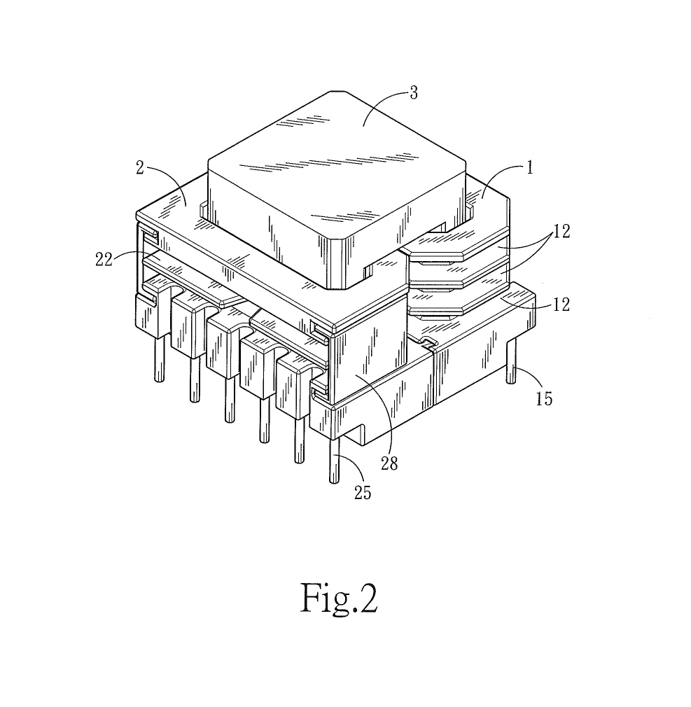

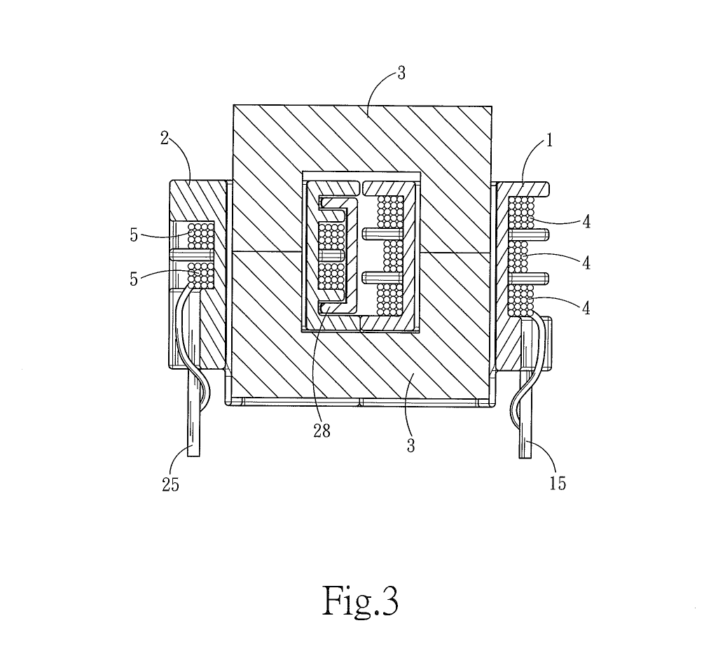

Referring to FIGS. 1 to 3, the structure of the present invention essentially includes: a first bobbin 1 and a second bobbin 2. A penetrating first center through-hole 11 is provided in the first bobbin 1, and a first winding slot group having a plurality of adjacent first winding slots 12 are provided on the outer peripheral side of the first center through-hole 11 (in this embodiment, the first winding slot group has three first winding slots 12). A laterally extending first receiving recess 16 is formed at a location on the first bobbin 1 corresponding to one end of the first center through-hole 11. A first pin group 15 including a plurality of pins and an opening are provided on two ends of the first receiving recess 16, respectively.

In one implementation, a first coupling portion 13 (which can be a dovetail tenon) and a first coupled portion 14 (which can be a dovetail mortise) are provided on two sides of the opening at one end of the first receiving recess 16, respectively.

A penetrating second center through-hole 21 is provided on the second bobbin 2. A second winding slot group having a plurality of adjacent second winding slots 22 and two clamping slots 27 are provided on the outer peripheral side of the second center through-hole 11 (the second winding slot group has two second winding slots 22 in the disclosed embodiment). The two clamping slots 27 can be provided on the top and bottom of the second winding slot group, respectively. A laterally extending second receiving recess 26 is formed at a location on the second bobbin 2 corresponding to one end of the second center through-hole 21. A second pin group 25 including a plurality of pins and an opening are provided on two ends of the second receiving recess 26, respectively.

In one implementation, the second bobbin 2 is provided with a shield 28 in the shape of an “n” near the opening of the second receiving recess 26. The shield 28 includes bent flanges 281 along two edges. The two flanges 281 are inserted into the two clamping slots 27, respectively, thereby fastening the shield 28 to the second bobbin 2. Furthermore, a second coupling portion 23 (which can be a dovetail tenon) to be correspondingly connected with the first coupled portion 14 and a second coupled portion 24 (which can be a dovetail groove) to be correspondingly connected with the first coupling portion 13 are provided on the sides of the opening at one end of the second receiving recess 26, respectively.

When assembled, the first coupling portion 13 (i.e. the dovetail tenon) of the first bobbin 1 is connected with (or wedged into) the second coupled portion 24 of the second bobbin 2 (i.e. the dovetail groove), and the second coupling portion 23 (i.e. the dovetail tenon) of the second bobbin 2 is connected with (or wedged into) the first coupled portion 14 of the first bobbin 1 (i.e. the dovetail groove), so the first bobbin 1 and the second bobbin 2 are joined together. The joined first bobbin 1 and second bobbin 2 have the center through-holes 11 and 21 extending parallel to each other, and the first and second pin groups 15 and 25 are arranged on the outer sides of the joined bobbins, respectively.

In practice, two sets of coils (a primary winding 4 and a secondary winding 5) are wound onto the first and second winding slots 12 and 22 of the first and second bobbins 1 and 2. The ends of the primary and secondary windings 4 and 5 are connected with the first and second pin groups 15, respectively. Then, the shield 28 is assembled onto the second bobbin 2. Following this, the first and second bobbins 1 and 2 are coupled together. The coupled first and second bobbins 1 and 2 can then be assembled with two “n-shaped” magnetic cores 3 that are facing each other.

Side portions 31 and 32 extend in parallel in the same direction from either end of the “n-shaped” magnetic cores 3. The two “n-shaped” magnetic cores 3 come into contact with each other via the side portions 31 inserted into the first center through-hole 11 from the top and bottom of the first bobbin 1, respectively, as well as via the side portions 32 inserted into the second center through-hole 21 from the top and bottom of the second bobbin 2, respectively. As such, a magnetic loop is formed between the two “n-shaped” magnetic cores 3, thereby forming a twin-shaft thin transformer structure.

In the above structure, the shield 28 forms an obstruction between the first and second bobbins 1 and 2, thus improving the insulation between the primary and secondary windings 4 and 5. In doing so, under the same insulation requirement, the primary and secondary windings 4 and 5 can use wires with less insulating layers, and would result in better heat dissipation. Meanwhile, by accommodating the “n-shaped” magnetic core” 3 closer to the first and second pin groups 15 and 25 in the first and second receiving recesses 16 and 26, when the first and second pin groups 15 and 25 are soldered onto a circuit board, the “n-shaped” magnetic core” 3 closer to the circuit board may be more completely enclosed and isolated, making it better at meeting various safety inspection specification.

Moreover, the number of windings distributed in each of the first winding slots 12 may be adjusted for the primary winding 4 as needed. Similarly, the number of windings distributed in each of the second winding slots 12 may be adjusted for the secondary winding 5 as needed in order to achieve a leakage inductance balance between the primary and secondary windings 4 and 5.

In one implementation, the first and second bobbins 1 and 2 can be designed into the same structure (e.g. both into the structure of the first bobbin 1 or the structure of the second bobbin 2). As such, when two identical bobbins having the structure of the first bobbin 1 are assembled together, there is no shield 28 between them, and it suited for products with lower insulation needs. On the contrary, when two identical bobbins having the structure of the second bobbins 2 are assembled together, there are two shields 28 between them, making it particularly suitable for (e.g. medical-grade) products with higher insulation needs.

In summary, the improved compact twin-shaft bobbin structure in accordance with the present invention meets the insulation requirements for medical-grade products, and is easy to wind while having stability in inductance and leakage inductance. In view of this, the present invention is submitted to be novel and non-obvious and a patent application is hereby filed in accordance with the patent law. It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

What is claimed is:

1. An improved compact twin-shaft bobbin structure comprising:
a first bobbin including a penetrating first center through-hole and a first winding slot group having a plurality of adjacent first winding slots on the outer peripheral side of the first center through-hole, a laterally extending first receiving recess formed at one end of the first center through-hole, and a first pin group including a plurality of pins and an opening provided on two ends of the first receiving recess, respectively;
a second bobbin including a penetrating second center through-hole, a second winding slot group having a plurality of adjacent second winding slots and two clamping slots on the outer peripheral side of the second center through-hole, a laterally extending second receiving recess formed at one end of the second center through-hole, and a second pin group including a plurality of pins and an opening provided on two ends of the second receiving recess, respectively, wherein a shield in the shape of an “n” is provided on one side of the second bobbin, the shield further includes bent flanges along two edges thereof, the two flanges are inserted into the two clamping slots, respectively, to fasten the shield to the second bobbin;
when the first and second bobbins are juxtaposed with their openings adjacent to each other, the first and second receiving recesses are in communication with each other, while the first and two center through-holes extend in parallel to each other with the first and second pin groups arranged at the sides of the first and second bobbins, respectively.

2. The improved compact twin-shaft bobbin structure of claim 1, wherein a first coupling portion and a first coupled portion are provided on two sides of the opening of the first bobbin, respectively, and a second coupling portion and a second coupled portion are provided on two sides of the opening of the second bobbin, respectively, the first coupling portion is correspondingly connected with the second coupled portion and the second coupling portion is correspondingly connected with the first coupled portion.

3. The improved compact twin-shaft bobbin structure of claim 2, wherein the first and the second coupling portions are dovetail tenons, and the first and the second coupled portions are dovetail grooves.

4. The improved compact twin-shaft bobbin structure of claim 1, wherein the two clamping slots are provided on the top and bottom of the second winding slot group, respectively.
